(19) United States
(12) Patent Application Publication
(10) Pub. No.: US 2004/0243879 A1
(43) Pub. Date: Dec. 2, 2004

(54) DRAM memory page operation method and its structure

(76) Inventors: Chien-Zu Hou, Fremont, CA (US); Hsiu-Ying Hsu, Taipei (TW)

Correspondence Address: PRO-TECHTOR INTERNATIONAL SERVICES, 20775 Norada Court, Saratoga, CA, 95070-3018, US

(21) Appl. No.: 10/867,063

(22) Filed: Jun. 12, 2004

Related U.S. Application Data
(63) Continuation of application No. 09/759,211, filed on Jan. 16, 2001.

(51) Int. Cl. G06F 12/00; G06F 12/08

(52) U.S. Cl. 714/8; 711/105; 711/207

(57) ABSTRACT

The present invention relates to a DRAM memory page operation method and its structure. The disclosed method comprises a set up procedure and an operation procedure. The set up procedure tests and finds out whether any deficit exists in the memory page of the memory and establishes a table of look-aside buffer that indicates defective locations and the corresponding new locations. The real operation procedure is executed after the set up procedure completes. It establishes a fast page lookup table according to results in the set up procedure for instructing the memory page or memory unit to operate in the normal access mode or the page operation mode. Good memory pages then replace bad memory pages according to the records in the fast page lookup table and the bad memory pages are moved to addresses at the very end of the memory so that the memory can operate even with deficits. Thus, no deficit in a single DRAM memory page/unit will halt the whole system.

### RELATED APPLICATION

This application is a continuation pursuant to 37 C.F.R. §1.53(b) of application “Dram Memory Page Operation Method and Its Structure”, Ser. No. 09/759,211 filed Jan. 16, 2001.

### BACKGROUND OF THE INVENTION

1. Field of the Invention

The present invention relates to a DRAM memory page operation method and its structure and, in particular, to a method of redirecting the bad and ineffective memory page in DRAM to normal memory pre-stored at the end of the memory so that the defective memory can normally operate.

2. Description of the Prior Art

The dynamical random access memory (DRAM) module 1 comprises a plurality of DRAM 10 and each DRAM 10 is a memory device composed of continuous memory pages 11 (or continuous cells). As shown in FIG. 1, the DRAM 10 has 16M of memory that is divided into 4096 memory pages 11 (000 to FFF) of the size 4K, the computer system accesses data DRAM 1 through a memory controller 20 and controls the access of each memory page 11 of the DRAM 10 through the supporting logic 12 in the DRAM module 1.

When the computer system is turned on, the basic input/output system (BIOS) will detect the DRAM 10. There may occur many errors or mistakes due to deficits or damages during the process of manufacturing the DRAM 10 so that deficits exist in a memory page 11 or cell of the DRAM 10. When the system accesses the DRAM 10 and finds a deficit at, for example, the memory page A03, then the whole system operation will stop at the memory page A03 and be forced to give up on accessing the defective DRAM module 1

In a personal digital assistant (PDA) or other small-sized communication devices, DRAM 10 is mostly embedded on the main board. If the embedded DRAM 10 has deficits, functions of the whole DRAM module 1 will be affected so that the operation logic cannot access the memory page 11, resulting in system halt, ineffective memory abandonment, and even quitting the whole system. The does not only lowers the yield for the DRAM manufacturers, but also wastes the system or other parts in the DRAM 10 that are functioning normally and causes great losses.

### SUMMARY OF THE INVENTION

Therefore, it is a primary object of the invention to provide a DRAM memory operation method and its structure. The present invention provides a memory controller and its operation method to move a bad memory page to the very end to be replaced by a good one so that the system operation will not stop due to the effects of the damaged memory page and the system does not need to give up on the whole memory module.

Pursuant to the foregoing object, the operation method comprises a set up procedure and an operation procedure. The set up procedure tests and finds out whether any deficit exists in the memory page of the memory and establishes a table of look-aside buffer that indicates defective locations and the corresponding new locations. The real operation procedure is executed after the set up procedure completes. It establishes a fast page lookup table according to results in the set up procedure for instructing the memory page or memory unit to operate in the normal access mode or the page operation mode. Good memory pages then replace bad memory pages according to the records in the fast page lookup table and the bad memory pages are moved to addresses at the very end of the memory so that the memory can operate even with deficits.

The structure of the disclosed DRAM memory page is as follows. The memory controller comprises a controller to control the access to each memory page, the controller having memory (e.g. flash memory or random access memory) for storing the table of look-aside buffer; static random access memory (SRAM) for storing the fast page lookup table that indicate whether the memory operates under the normal access mode or the page operation mode.

Other features and advantages of the present invention will be apparent from the following detailed description, which proceeds with reference to the accompanying drawings.

### BRIEF DESCRIPTION OF THE DRAWINGS

FIG. 1 is a schematic view of the conventional memory module structure;

FIG. 2 is a schematic view of the memory module structure of the present invention;

FIG. 3 is a flow chart of the set up procedure of the invention; and

FIG. 4 is a flow chart of the operation procedure of the invention.

In the various drawings, the same references relate to the same elements.

### DETAILED DESCRIPTION OF THE INVENTION

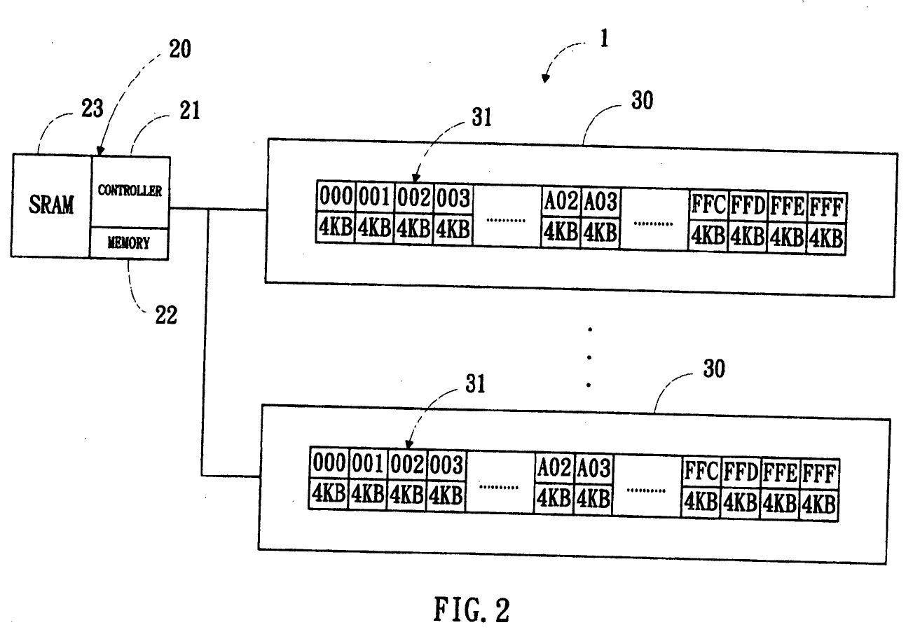

As shown in FIG. 2, the disclosed DRAM memory page structure comprises a dynamical random access memory (DRAM) 30 and a memory controller 20; wherein the DRAM 30 includes a plurality of memory pages 31 (or cells), and the memory controller 20 includes a controller 21, which controls the access of each memory page 31 and has memory 22 therein for storing the result of storage settings (the details are described later), a static random access memory (SRAM) 23, which stores a fast page lookup table comprising a plurality of indication bits that map to memory pages to indicate whether the memory pages 31 are operating under the normal access mode or the page operation mode (which is to be explained later).

The memory page operation method comprises a set up procedure and an operation procedure.

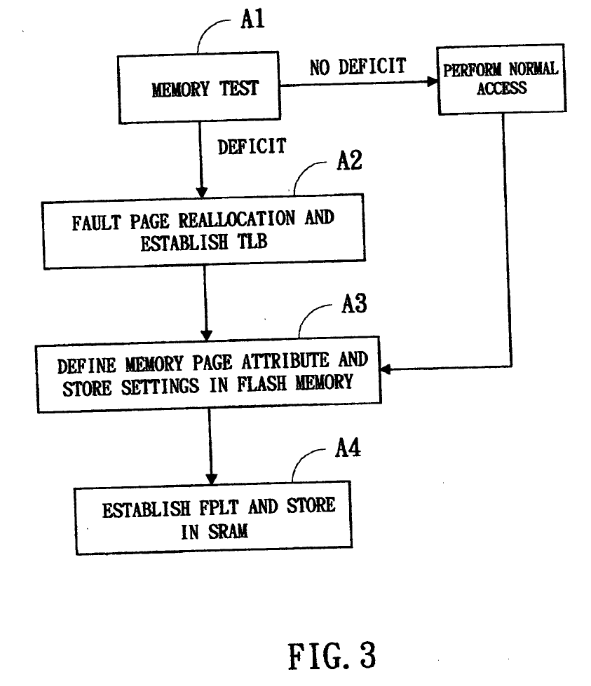

Set Up Procedure (FIG. 3)

When the disclosed DRAM 30 is first used or each time the system is turned on, the set up procedure of fault page reallocation for the DRAM 30 will be executed according to the following steps:

Step A1: Memory Test

BIOS will be initialized to test whether any deficit exists in the DRAM 30. If no deficit is detected, then the access to the DRAM 30 is operating normally. BIOS will skip the fault reallocation (Step A2) and execute an attribute processing (Step A3). If any deficit is detected to be in the DRAM 30, BIOS will start the procedure to establish a table of look-aside buffer (Step A2).

Step A2: Fault Page Reallocation

When a deficit is detected in the DRAM 30, the system will start the procedure to establish a table of look-aside buffer (TLB) to indicate defective locations and new locations mapped into. The TLB will be stored in the memory 22 of the memory controller 20 (FIG. 2), which can be flash memory or random access memory (RAM). For example, with reference to both FIG. 2 and Table 1, memory pages 000, 003, A02 and A03 are the ones with deficits and are mapped into new memory pages FFC, FFD, FFE and FFF, respectively.

TABLE 1

| Old Page | [symbol] | New Page |
|---|---|---|
| 000 | | FFC |
| 003 | | FFD |
| A02 | | FFE |
| A03 | | FFF |

Step A3: Page Attribute Processing

Within the TLB, the controller 21 provides a plurality of selection items defined by the user in addition to the mapping addresses. The selection items can be used in defective memory pages and normal memory pages, including attributes such as read only, read once, read twice, write only, write once, write twice, address relocation, etc (Table 2).

TABLE 2

| | | Page Attribute | | | | | |
|---|---|---|---|---|---|---|---|
| | Fault | | Read | Read | Write | Write | Write |
| Page | Mapping | Read Only | Once | Twice | Only | Once | Twice |
| 003 | FFD | No | No | No | No | No | No |
| 008 | No | Yes | Yes | No | No | Yes | No |
| A02 | FFE | No | No | No | Yes | Yes | Yes |

Step A4

After the set up procedure is completed, the system will establish a fast page lookup table (FPLT), which is stored in the SRAM 23 shown in FIG. 2. The FPLT indicates whether the memory pages 31 or cells are operating under the normal access mode or the page operation mode.

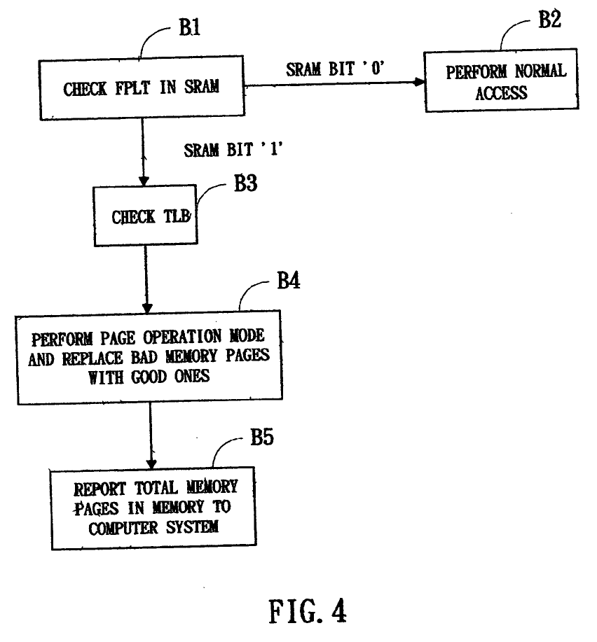

Operation Procedure (FIG. 4)

Taking a 16M DRAM module as an example, there are 4096 memory pages 31 (or cells) of the size 4K. The size of the SRAM is the number of the mapping memory page. The SRAM 23 (4K or 4096 bits) corresponds to the memory page 31 of each DRAM 30 for indicating whether the memory page 1 is operating under the normal access mode or the page operation mode. The actual operation procedure includes unique two-level mapping procedures. The first mapping checks the FPLT stored in the SRAM 23, as shown in Table 3 (Step B1). When the SRAM 23 bit corresponding to some memory page 31 is “0”, that memory page is operating under the normal access mode (Step B2). When the SRAM 23 bit of some memory page 31 is “1”, that memory page is under the page operation mode. Therefore the second level mapping is involved. The system controller checks the TLB stored in the flash memory of the controller 21 (Step B3) to fetch the page attributes and the real mapping addresses toward DRAM.

TABLE 3

| | Page | | | | | | | | | | | | | |
|---|---|---|---|---|---|---|---|---|---|---|---|---|---|---|
| | 000 | 001 | 002 | 003 | . . . | 008 | . . . | A02 | A03 | . . . | FFC | FFD | FFE | FFF |
| FPLT | 1 | 0 | 0 | 1 | | 1 | | 1 | 1 | | | | | |

For example, in Table 3 the FPLT of page 000 is “1” because this is a fault page. On the other hand, even though page 008 does not have any deficit, the FPLT of the page can be “1”, which is due to the read only or write once attribute set by the user.

If several memory pages 31 do not function normally (as shown in Table 1, memory pages 000, 003, A02 and A03 are detected to be defective), the defective result is written into the flash memory 22. When the computer system is turned on, the test result of defective memory pages 31 will be loaded into the SRAM 23 and one can quickly learn whether those memory pages 31 are damaged by referring to the FPLT stored therein.

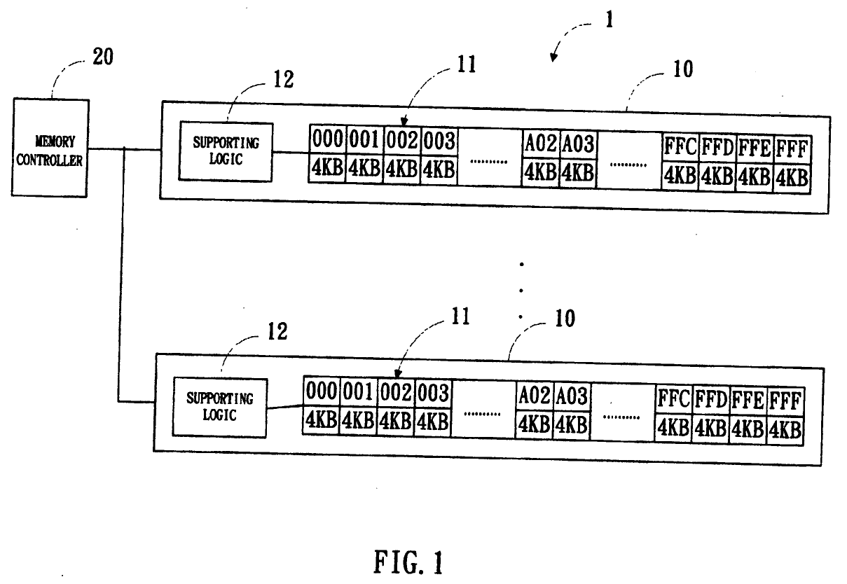

The bad memory pages will be replaced by good pages with addresses residing at the end of DRAM 30 according to the present invention. As shown in FIG. 1, four memory pages are bad and are to be replaced. The TLB points to addresses FFC, FFD, FFE and FFF in order to replace the bad memory pages thereby (Step B4). That is, the memory page 000 is replaced by the memory page FFC, the memory page 003 is replaced by the memory page FFD, the memory page A02 is replaced by the memory page FFE and the memory page A03 is replaced by the memory page FFF. The bad memory pages are appended to the end addresses of the memory DRAM 30. Since memory pages in the DRAM 30 are damaged, after replacing the bad memory pages by good ones the setting procedure will report the total number of memory pages 31 in the computer system chip, excluding defective memory pages (it is 4092 memory pages in the current embodiment) so that no access to defective memory pages will occur when the next time the memory pages 31 are accessed.

In conclusion, according to the disclosed DRAM memory page operation method and its structure, when defective memory pages 31 are detected while accessing the memory pages 31, later part of good memory pages 31 will be used to replace the bad ones and the bad memory pages 31 are appended to the end addresses of the DRAM 30 so that the memory 31 can operate normally and correctly even deficits exist. The system will not halt simply due to the deficit of a single DRAM memory page. One also does not need to waste resources and money to replace the whole memory module simply because one memory page is damaged The present invention thus provides an effective solution to the problem of replacing the whole DRAM owing to deficit memory in the prior art.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A DRAM memory page operation method, which comprises a set up procedure and an operation procedure; wherein said set up procedure includes the following steps:
a) testing memory to find out whether any deficit exists in a memory page;
b) fault page reallocation to establish a table of look-aside buffer (TLB) so as to indicate defective locations and the corresponding new locations mapped into;
c) page attribute processing to establish selection items that define memory page operation modes in the TLB;
d) establishing a fast page lookup table (FPLT) according to the result of the set up procedure for indicating whether the memory page or memory unit is operating under the normal access mode or the page operation mode; and wherein
said operation procedure then checks the FPLT and said TLB so as to replacing bad memory pages by good ones and appending said bad ones to the latest addresses in the memory.

2. A DRAM memory page operation method as recited in claim 1, wherein: said step of testing memory is started by the basic input/output system (BIOS).

3. A DRAM memory page operation method as recited in claim 1, wherein: said page attributes include such selection items as read only, write only, write once and read once that are applicable to both defective memory and normal memory.

4. A DRAM memory page operation method as recited in claim 1, wherein: after memory page replacing in said operation procedure the set up procedure will report the number of total memory pages, excluding bad memory pages, to the computer system so that no access to defective memory pages will occur when the next time the memory pages are accessed.

5. A DRAM memory page operation method as recited in claim 1, wherein: said operation procedure further comprises unique two-level mapping procedures for checking the mapping bits in the FPLT stored in SRAM so as to determine memory pages.

6. A DRAM memory page operation method as recited in claim 5, wherein: the first mapping indicates that a memory page is operating in the normal access mode when the bit is “0”.

7. A DRAM memory page operation method as recited in claim 5, wherein: the second mapping indicates that the memory page is operating in the page operation mode when the bit is “1” and the system checks the TLB stored in flash memory in the controller to confirm the page attributes and the actual mapping addresses.

8. A DRAM system structure, which comprises:
a) at least one Dynamic Random Access Memory (DRAM) including a plurality of memory pages (cells);
b) a memory controller including:
i) a controller, which controls the access of each memory page and has memory for storing the set up procedure result described in claim 1;
ii) an SRAM, which stores a FPLT that has a plurality of indication bits mapping into memory pages for indicating whether the memory pages are operating under the normal access mode or the page operation mode.

9. The DRAM structure as recited in claim 8, wherein: said memory is a flash memory or a volatile memory of RAM.

10. The DRAM structure as recited in claim 8, wherein: the size of said SRAM corresponds to the number of memory pages.
